(19) United States
(12) Patent Application Publication
(10) Pub. No.: US 2003/0107741 A1
(43) Pub. Date: Jun. 12, 2003

(54) Surface plasmon resonance sensor system

(76) Inventors: Hyeon Bong Pyo, Yusong-Gu (KR); Yong Beom Shin, Seo-Gu (KR); Ji Wook Jeong, Yusong-Gu (KR); Min Gon Kim, Yusong-Gu (KR); Sang Kyung Lee, Yusong-Gu (KR); Dong Ho Shin, Yusong-Gu (KR); Seon Hee Park, Seo-Gu (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/154,606

(22) Filed: May 22, 2002

(30) Foreign Application Priority Data
Dec. 11, 2001 (KR) 2001-78270

(51) Int. Cl. G01N 21/55

(52) U.S. Cl. 356/445

(57) ABSTRACT

The present invention relates to a sensor system for measuring the changes of refractive index and for the thickness variation of a sample medium, and the variations in concentration of a liquid sample using a surface plasmon resonance (SPR) or a sensor chip constituting the surface plasmon microscope (SPM). The surface plasmon resonance sensor system comprises a sensor chip having a sensor element on which a measuring sample is located, the sensor element is composed of a first adhesion layer, a conductive thin film, a second adhesion layer and a transparent thin film sequentially stacked on a transparent substrate; a prism attached under the sensor chip; a light source for providing light to the sensor chip through the prism; and a light-detecting element for measuring variations in the refractive index caused by resonance of surface plasmon on the conductive thin film.

### BACKGROUND OF THE INVENTION

1. Field of the Invention

The present invention relates generally to a surface plasmon resonance sensor system, and more particularly to a sensor system for measuring the change of refractive index and the thickness of a sample medium or changes in the concentration of a liquid sample using a surface plasmon resonance (SPR) and a sensor chip used in a surface plasmon microscope (SPM).

2. Description of the Prior Art

Generally, the surface plasmon resonance sensor system is used to measure the change of the refractive index, thickness or changes in the concentration of a medium using resonance absorption of surface plasmon oscillating on the metal surface.

FIG. 1 shows a conventional surface plasmon resonance (SPR) sensor system. The surface plasmon resonance sensor system includes a surface plasmon resonance sensor chip 3, a prism 2 attached under the surface plasmon resonance sensor chip 3, a light source 1 for providing light to the sensor chip 3 through the prism 2, and a light-detecting element 4 for sensing light reflected from the sensor chip 3.

The surface plasmon resonance sensor chip 3 has an adhesion layer 3b and a thin metal film 3c sequentially stacked on a substrate 3a which has the same refractive index of the prism 2. The thin metal film 3c for generating surface plasmon is formed of noble metals such as gold, silver, etc. Also, the adhesion layer 3b for the adhesion of the metal film 3c and the substrate 3a is usually made of chrome (Cr) or titanium (Ti).

The prism 2 is made of a transparent medium which has the refractive index of n_{d}=1.5˜1.9 such as BK7, SF10, and the like. The shape of the prism 2 may be triangular or hemi-cylindrical.

The light source 1 has a transverse magnetic (TM) or a P-polarized monochromatic light source such as laser or a white light to provide the light having with a single or multiple wavelength, respectively.

In case of a single channel, the light-detecting element 4 is composed of a photodiode. In case of a multiple channel, the light-detecting element 4 is composed of an optical camera, a charge-coupled device (CCD), etc.

If a sample 5 to be measured is located on the surface plasmon resonance sensor chip 3, light from the light source 1 is incident to the substrate 3a by a given angle (θ) through the prism 2. Also, when a wave-vector component in parallel to the surface of the thin metal film 3c couples with the wave-vector of the surface plasmon, most of the energy of the incident light is absorbed by the surface plasmon on the metal surface 3c. In this case, the distribution of electric field induced by resonance absorption is exponentially decayed in both directions of the interface of the thin metal film 3c and the sample 5. Therefore, the resonance absorption condition of the surface plasmon is varied very sensitively, depending on the thickness and the refractive index of the sample 5 on the surface of the thin metal film 3c or the variations of the concentration of a liquid sample. As this varies a reflectivity of light, it is possible to know quantitatively the variations of the refractive index, of the thickness or the concentration of a sample by measuring a reflectivity by moving the light-detecting element 4.

A method of measuring a refractive index of the sample using the surface plasmon resonance includes the following prior arts:

(a) A method of measuring the resonance angle satisfying the above condition and its variation while changing the incident angle of light, wherein light having a single wavelength is incident to a prism having a fixed refractive index (U.S. Pat. No. 4,889,427);

(b) A method of measuring variations in the wavelength depending on the resonance condition, wherein a light source having a multiple wavelength such as white light is employed and the incident angle of light is fixed (U.S. Pat. No. 5,359,681);

(c) A method of measuring the resonance angle using a multiple-channel light-detecting element such as a photodiode array (PDA), etc., wherein an expanded, monochromatic light source is focused on the center of a transparent medium (U.S. Pat. No. 4,844,613, etc.);

(d) A surface plasmon microscope method, that is, a method of measuring the variations of the refractive indexes on two-dimension at each point by using light supplied from a light source with an expanded single wavelength and changes of the contrast for each channel, wherein a light-detecting element of a multiple channel is arranged on the two-dimensional plane (U.S. Pat. No. 5,028,132).

As such, in the conventional sensor system which is constructed to measure the refractive index change of a sample or changes of the dielectric function using the surface plasmon resonance, a thin metal film made of noble metals (gold, silver, etc.) that supports the surface plasmon is located on the top of the sensor chip. Therefore, it is difficult to use such a SPR sensor chip to immobilize the nucleic acid or protein on the glass by using the silane as a linker.

### SUMMARY OF THE INVENTION

It is therefore an object of the present invention to provide a surface plasmon resonance sensor system in which a transparent medium is formed on top of a thin metal film that supports surface plasmons and an adhesion layer is formed between the transparent medium and the metal film.

Another object of the present invention is to use silver that is cheap and has a good surface plasmon resonance (SPR) characteristic instead of gold, by coating a transparent medium on a thin metal film in order to prevent oxidation of the silver metal film.

Still another object of the present invention is to significantly reduce the cost consumed to manufacture a sensor chip and to be applied to a system having a sensor chip for immobilizing nucleic acid or protein using silane as a linker.

In order to accomplish the above objects, a surface plasmon resonance sensor system according to the present invention, is characterized in that it comprises a sensor chip having a sensor element on which a sample to be measured is located, the sensor element is composed of a first adhesion layer, conductive thin film, a second adhesion layer and a transparent dielectric film sequentially stacked on a transparent substrate; a prism attached under the sensor chip; a light source for providing light to the sensor chip through the prism; and a light-detecting element for measuring variations in the refractive index caused by of surface plasmon resonance on the conductive thin film.

The first and second adhesion layers are made of chrome (Cr) or titanium (Ti). The conductive thin film is made of gold (Au), silver (Ag), copper (Cu), aluminum (Al) or semiconductor. The transparent dielectric thin film is made of SiO₂, TiO₂, etc.

A sensor element is formed in multiple on the substrate. The prism is triangular or hemi-cylindrical and is made of a material having the same refractive index as the substrate.

### BRIEF DESCRIPTION OF THE DRAWINGS

The aforementioned aspects and other features of the present invention will be explained in the following description, taken in conjunction with the accompanying drawings, wherein:

FIG. 1 shows a conventional surface plasmon resonance (SPR) sensor system;

FIG. 2 shows a surface plasmon resonance (SPR) sensor system according to the present invention;

FIG. 3a and FIG. 3b are plan views of the sensor chips in FIG. 2;

FIG. 4 is a graph illustrating a result of measuring a reflectivity of water and ethanol used as a sample as a function of SPR angle; and

FIG. 5 is a graph illustrating the calibration curve as a function of refractive index change of a sample and the SPR angle.

### DETAILED DESCRIPTION OF PREFERRED EMBODIMENTS

The most important thing in a structure of a surface plasmon resonance (SPR) sensor chip is the thin metal film for generating a surface plasomon. The thin metal film of the surface plasmon resonance (SPR) sensor chip used in the field of somatology is usually made of gold (Au) that biocompatible and chemically inert than silver (Ag) such as oxidation problem. Therefore, a lot of cost is needed to fabricate the sensor chip used in the field of diagnostic systems.

Further, in a sensor system for immobilizing protein on the surface of a glass (SiO₂) such as a cover glass using silane as a linker and measuring a selective coupling using a fluorescent material, it is difficult to use a conventional surface plasmon resonance (SPR) sensor having a thin metal film formed on a surface.

Therefore, the present invention provides a sensor chip capable of solving these problems. The present invention will be described in detail by way of a preferred embodiment with reference to accompanying drawings, in which like reference numerals are used to identify the same or similar parts.

FIG. 2 shows a surface plasmon resonance (SPR) sensor system according to the present invention. The surface plasmon resonance (SPR) sensor system includes a surface plasmon resonance sensor chip 13, a prism 12a attached under the sensor chip 13, a light source 11 for providing light to the sensor chip 13 through the prism 12, and a light-detecting element 14 for sensing light reflected from the sensor chip 13.

The surface plasmon resonance sensor chip 13 has a first adhesion layer 13b, a thin metal film 13c, a second adhesion layer 13d and a transparent thin film 13e sequentially stacked on the substrate 13a. The substrate 13a is made of a transparent medium having the same or similar (n_{d}=1.5˜1.9) to a refractive index of the prism 12. The first and second adhesion layers 13b and 13d for better adhesion between the substrate 13a and the thin metal film 13c, and the thin metal film 13c and the transparent thin film 13e are usually formed of chrome (Cr), titanium (Ti), etc. Also, the first and second adhesion layers 13b and 13d are deposited in thickness of about several nanometers (d=1˜5 nm) by means of vacuum evaporation method. The thin metal film 13c to support surface plasmon resonance (SPR) is formed on noble metals such as gold (Au), silver (Ag), etc. and is deposited in thickness of about several nanometers (nm) by means of vacuum evaporation method. If the SPR sensor system does not include the transparent thin film 13e, it is preferred that the thin metal film 13c is formed in thickness of about 40˜50 nm. Further, the thin metal film 13c may be formed of another kind of metal, for example, copper (Cu), aluminum (Al), semiconductor, etc. The transparent thin film 13e is formed of a transparent medium such as SiO₂, TiO₂, or the like.

The prism 12 is made of a transparent medium having a high refractive index (n_{d}=1.5˜1.9) such as BK7, SF10, and the like. The shape of the prism 12 may be triangular or hemi-cylindrical.

An index matching oil or silicon rubber made of a similar transparent material having the same refractive index to the substrate 13a or the prism 12 is filled between the surface plasmon resonance sensor chip 13 and the prism 12.

The light source 11 may include TM or P-polarized monochromatic light source, white light source, laser, light-emitting diode (LED) for providing light having a single wavelength or a multiple wavelength. The light-detecting element 14 may include a photodiode, an optical amplifier, a charge-coupled device (CCD), photosensitive paper, and the like.

If a sample 15 to be measured is positioned on the transparent thin film 13e of the surface plasmon resonance sensor chip constructed above, light from the light source 11 is incident to the substrate 13a at a given angle (θ) through the prism 12. Then, the light totally reflected within the prism 12 is directed to the light-detecting element 14. In other words, if a wave vector component of the incident light which is parallel to the surface of metal layer 13c matches to that of the electron density fluctuated along the boundary of the surface of the thin metal film 13c and the sample 15 located on the surface of the thin metal film 13c, that is the wave vector of the surface plasmon, most of the energy of the incident light is absorbed in the surface plasmon. At this time, the electric field induced by the surface plasmon resonance, decays exponentially in both directions of the thin metal film 13c and the measured sample 15. Therefore, in case of a sample is located on a thin metal film, a resonance absorption condition of the surface plasmon is sharply changed depending on the thickness and the refractive index of the sample. And in case of a liquid sample, a resonance absorption condition of the surface plasmon is sharply changed depending on changes of the concentration of the liquid sample. As this variation changes a reflectivity of light, it is possible to know quantitatively the variations of the refractive index, of the thickness or the concentration of a sample by measuring the changes of the reflectivity using the light-detecting element 14.

At this time, the light source 11 may include a laser or a light-emitting diode (LED) of a monochromatic light, or a white light or a LED of a multiple wavelength band depending on the parameter that determines the surface plasmon resonance (SPR) condition, that is, the wavelength of an incident light under the fixed angle or an incident angle at a fixed wavelength. The light supplied from the light source is focused through an optical system or is incident to the prism 12 in parallel.

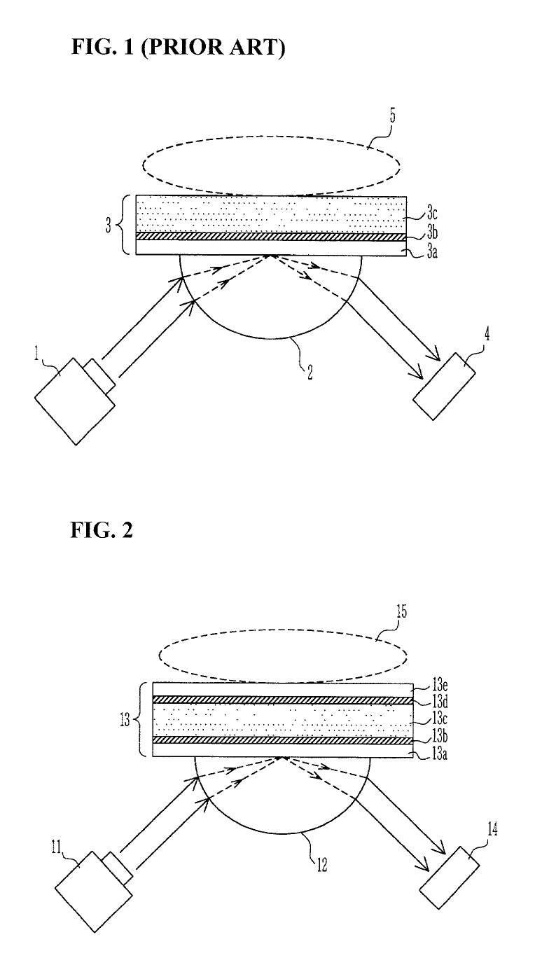

If the incident light has an expanded shape and is incident to the prism 2, as shown in FIG. 1, it is possible to measure the reflectivity in an extended range using a photodiode array (PDA) without any moving part. Further, it is possible to measure quantitatively the changes of the refractive index of the sample that depends on the changes of the surface plasmon resonance (SPR) condition, by fixing the incident angle while the white light source is used and measuring changes of the wavelength spectrum when the surface plasmon resonance (SPR) condition is satisfied.

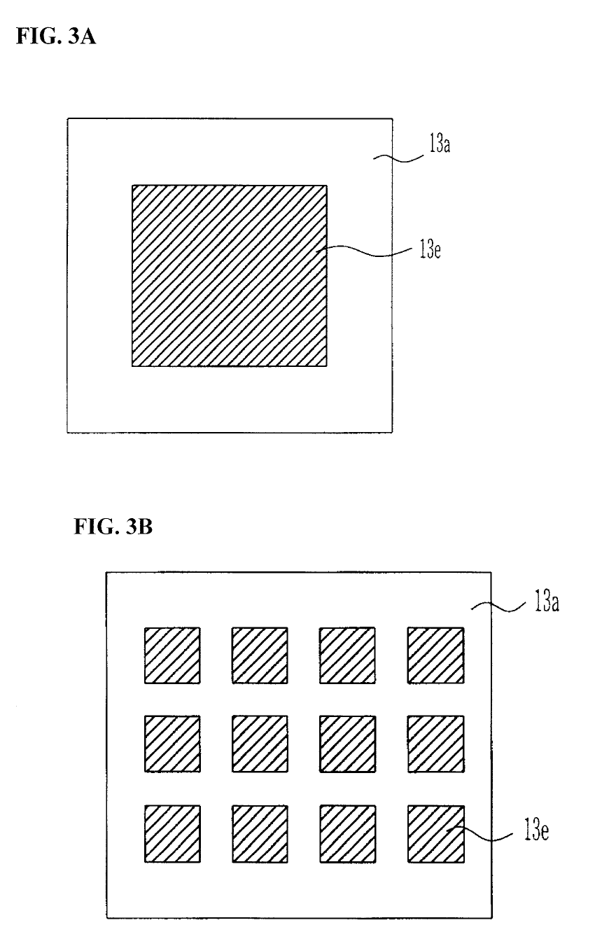

FIG. 3a is a plane view of a surface plasmon resonance sensor chip used when the type of a sample medium to be tested and the channel of the sensor is one, which shows a sensor chip usually used in the field of biotechnology.

A sensor element having a rectangular shape is formed on a substrate 13a. The sensor element is composed of a first adhesion layer 13b, a thin metal film 13c, a second adhesion layer 13d and a transparent thin film 13e stacked on the substrate 13a as shown in FIG. 2. After a sample to be measured is located on the transparent thin film 13e of the sensor element, variations in the refractive index of the sample is known by measuring its reflectivity.

FIG. 3b is a plane view of a surface plasmon resonance sensor chip used when the type of a sample medium to be measured and the channel of the sensor are multiple, which shows a biochip such as a DNA chip or a protein chip.

A plurality of sensor elements having a rectangular shape is formed on a substrate 13a. Each sensor element is composed of a first adhesion layer 13b, a thin metal film 13c, a second adhesion layer 13d and a transparent thin film 13e stacked on the substrate 13a as shown in FIG. 2. The sensor element measures changes of the contrast in each channel depending on the resonance condition of the surface plasmon.

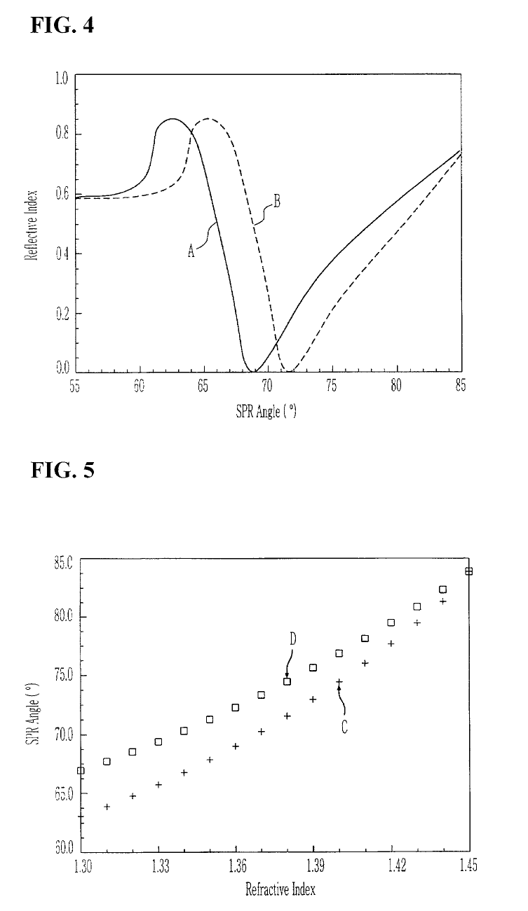

FIG. 4 is a graph illustrating a result of the SPR reflectivity of water and ethanol, used as a sample, as a function of SPR angle.

Water (H₂O) and ethanol (C₂H₆O) are used as the sample to measure the refractive index. The sample is located on the surface plasmon resonance sensor chip 13. The surface plasmon resonance sensor chip 13 is composed of chrome (the first adhesion layer 13b) having the thickness of 2 nm, silver (Ag) (the thin metal film 13c) having the thickness of 26 nm, chrome (the second adhesion layer 13d) having the thickness of 2 nm and SiO₂ (the transparent thin film 13e) having the thickness of 30 nm sequentially stacked on the substrate 13a. At this time, the prism 12 made of BK7 are used, and a TM-polarized laser diode (LD) having a wavelength (λ) of 830 nm is used as the light source 11. The refractive index of water (H₂O) and ethanol (C₂H₆O) is 1.328 and 1.358, respectively, wherein the difference is about 0.03. The surface plasmon resonance angle (SPR angle) of water and ethanol is θ_{SPR}=68.7° and θ_{SPR}=71.6° respectively, wherein the difference is about 2.9°. It can be known that the sensitivity of a sensor is about 1×10⁻⁶ RI (Refractive Index) when the resolution of the angle is 1×10⁻⁴°. In FIG. 4, line A indicates the SPR reflectivity of water and line B indicates that of ethanol.

Meanwhile, as a result of measuring a reflectivity of water and ethanol as a sample using a conventional sensor chip having BK7 (the substrate 3a), Cr (the adhesion layer 3b) and gold (Au) having the thickness of 45 nm (the thin metal film 3c), the SPR resonance angle was θ_{SPR}=65.3° and θ_{SPR}=68.4° respectively, with the difference of about 3.1°. Considering this difference, it could be seen that there is no significant difference in the sensitivity from the sensor chip of the present invention.

FIG. 5 is a graph illustrating the calibration curve that is the SPR angle change as a function of the refractive index of a sample. In view of the linearity between the refractive index and the surface plasmon resonance (SPR) angle, it could be seen that the result from the sensor chip of the present invention shows rather better behavior. In FIG. 5, line C indicates a linearity of the conventional sensor chip and a line D indicates a linearity of the sensor chip of the present invention.

Therefore, according to the present invention, if a surface plasmon resonance (SPR) sensor system is implemented using a sensor chip of the present invention, the sensitivity is not degraded compared to a conventional sensor system while the possibility of applications is extended.

As mentioned above, the present invention includes a transparent thin film formed on a surface plasmon supporting metal film and an adhesion layer that may be formed between the metal layer and transparent film. Therefore, the transparent thin film can prevent the degradation such as an oxidation of the metal film when the thin metal film is in contact with a liquid sample.

Further, the present invention can reduce the cost of fabrication of the sensor chip by using silver (Ag) rather than gold (Au) as a surface plasmon supporting metal layer, and it can also extend the use of the sensor for immobilizing nucleic acid or protein with the use of silane as a linker that is routinely used in the biology, and a sensor system for measuring a selective coupling using the same.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. A surface plasmon resonance sensor system, comprising:
a sensor chip having a sensor element on which a sample to be measured is located, said sensor element is composed of a first adhesion layer, a conductive thin film, a second adhesion layer and a transparent dielectric film sequentially stacked on a transparent substrate;
a prism attached under said sensor chip;
a light source for providing light to said sensor chip through said prism; and
a light-detecting element for measuring variations in the refractive index caused by of surface plasmon resonance on said conductive thin film.

2. The surface plasmon resonance sensor system as claimed in claim 1. wherein said first and second adhesion layers are made of either chrome (Cr) or titanium (Ti).

3. The surface plasmon resonance sensor system as claimed in claim 1, wherein said conductive thin film is made of any one of gold (Au), silver (Ag), copper (Cu), aluminum (Al) and semiconductor.

4. The surface plasmon resonance sensor system as claimed in claim 1, wherein said transparent dielectric film is made of either SiO₂ or TiO₂.

5. The surface plasmon resonance sensor system as claimed in claim 1, wherein said sensor element is formed in multiple on said substrate.

6. The surface plasmon resonance sensor system as claimed in claim 1, wherein said prism has a triangular shape or a hemi-cylindrical shape.

7. The surface plasmon resonance sensor system as claimed in claim 1, wherein said prism is made of a material having the same refractive index as said substrate.

8. The surface plasmon resonance sensor system as claimed in claim 1, wherein the refractive index of said prism is 1.5˜1.9.

9. The surface plasmon resonance sensor system as claimed in claim 1, wherein said light source is either a monochromatic light source or a white light source, said light source is one of a TM-polarized laser, a TM-polarized light-emitting diode (LED) and a TM-polarized halogen lamp.

10. The surface plasmon resonance sensor system as claimed in claim 1, wherein said light-detecting element is one of a photodiode, an optical amplifier, a charged-coupled device (CCD) and a photosensitive paper.

11. The surface plasmon resonance sensor system as claimed in claim 1, wherein a medium having an optical characteristic is filled between said surface plasmon sensor chip and said prism.

12. The surface plasmon resonance sensor system as claimed in claim 11, wherein said medium having an optical characteristic is either an index matching oil or a silicon rubber having the same refractive index as said that of substrate and said prism.
